(19) United States
(12) Patent Application Publication
(10) Pub. No.: US 2015/0356588 A1
(43) Pub. Date: Dec. 10, 2015

(54) E-COMMERCE SYSTEM AND METHOD

(71) Applicant: Peigen Jiang, Sammamish, WA (US)

(72) Inventor: Peigen Jiang, Sammamish, WA (US)

(21) Appl. No.: 14/298,969

(22) Filed: Jun. 9, 2014

(51) Int. Cl. G06Q 30/02; G06Q 30/06

(52) U.S. Cl. CPC G06Q 30/0218; G06Q 30/0282; G06Q 30/0625

(57) ABSTRACT

A computer system is described which comprises a server computer connected to the Internet, the server computer receiving, over the Internet, both a product review and a product inquiry from a user on one or more remote computers, the product being reviewed being different from the product being inquired, a database containing product information pertaining to the inquired product, the product information including a first price of the inquired product, a processing unit calculating a second price from the first price and a factor derived from the product review, a computer program residing in the server computer placing the second price on a webpage pertaining to the inquired product, the computer program also sending the webpage to the user's remote computer.

### BACKGROUND

The present invention relates generally to electronic commerce (E-commerce) conducted over the Internet, and, more particularly, to linking online purchase to product review.

According to surveys, large number of people reported that a positive recommendation from a friend, family member, or someone they trust is the biggest influence on whether they buy a product or service. With the advance of the Internet, particularly the social media, the spread of recommendations has become much easier. As a result, product review has become a very powerful marketing tool for businesses.

The Internet has also made it easy for manufacturers to sell goods directly to end users, because manufacturers can disseminate product information and communicate with customers easily through the Internet.

As such, what is desired is a review system and method that facilitate manufacturer's selling direct to end users.

### SUMMARY

A computer system is described which comprises a server computer connected to the Internet, the server computer receiving, over the Internet, both a product review and a product inquiry from a user on one or more remote computers, the product being reviewed being different from the product being inquired, a database containing product information pertaining to the inquired product, the product information including a first price of the inquired product, a processing unit calculating a second price from the first price and a factor derived from the product review, a computer program residing in the server computer placing the second price on a webpage pertaining to the inquired product, the computer program also sending the webpage to the user's remote computer.

The construction and method of operation of the invention, however, together with additional objects and advantages thereof, will be best understood from the following description of specific embodiments when read in connection with the accompanying drawings.

### BRIEF DESCRIPTION OF THE DRAWING

FIG. 1 illustrates an E-commerce system.

FIGS. 2A and 2B illustrate exemplary webpages of an E-commerce website.

FIG. 3 illustrates a method for generating price information for a particular buyer.

FIG. 4 illustrates a method for calculating review credits.

FIG. 5 illustrates a server system 500 that hosts the E-commerce website of the present invention.

FIG. 6 is a flow-chart illustrating a process of a user initiating a product review on the E-commerce website.

FIG. 7 is a flow chart illustrating a process of a manufacturer initiating a product for sale on the E-commerce website

The drawings accompanying and forming part of this specification are included to depict certain aspects of the invention. A clearer conception of the invention, and of the components and operation of systems provided with the invention, will become more readily apparent by referring to the exemplary, and therefore non-limiting, embodiments illustrated in the drawings, wherein like reference numbers (if they occur in more than one view) designate the same elements. The invention may be better understood by reference to one or more of these drawings in combination with the description presented herein.

### DESCRIPTION

The present invention relates to the E-commerce conducted over the Internet that utilizes product reviews to facilitate vender's selling direct to end users.

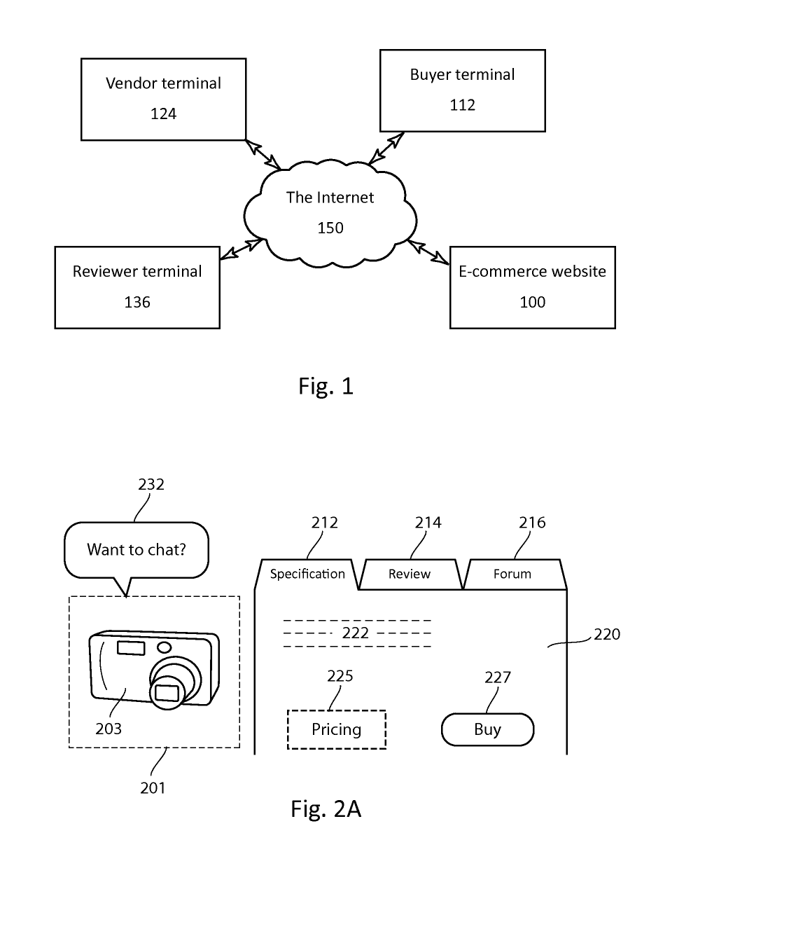

FIG. 1 illustrates an E-commerce system which includes an E-commerce website 100 residing in a server, a remote terminal belongs to an exemplary buyer 112, a remote terminal belongs to an exemplary vendor 124, and a remote terminal belongs to an exemplary reviewer 136, all connected to the Internet 150. The buyer 112 can purchase products from the vendor 124 through the E-commerce website 100. The reviewer 136 can post reviews of products either from the vendor 124 or elsewhere on the E-commerce website 100. In some embodiments, the buyer 112 and the reviewer 136 can be the same person.

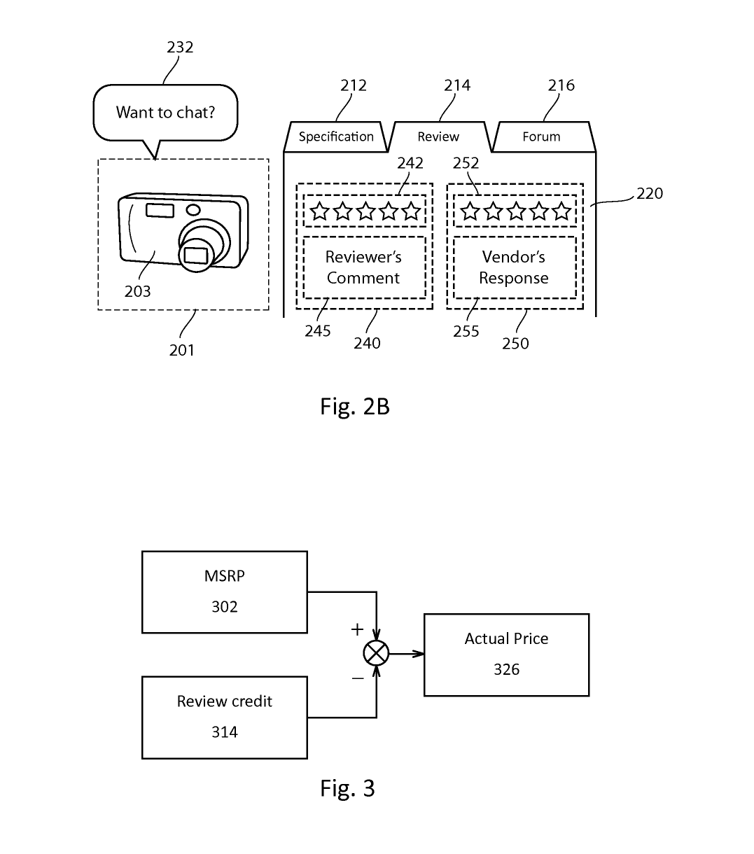

FIGS. 2A and 2B illustrate exemplary webpages of the E-commerce website 100. Referring to FIG. 2A, a first exemplary webpage includes a product image area 201 which, for instance, displays a camera 203 for sale. The first exemplary webpage also includes a specification tab 212, a review tab 214, and a forum tab 216. When the specification tab 212 is selected, product information 222 pertaining to the for-sale camera 203 will be displayed in a region 220. In addition, a box 225 containing pricing information and a “buy” button 227 are also displayed in the region 220.

When the review tab 214 is selected, the region 220 will display reviews pertaining to the for-sale camera 203. In embodiments, a review has to be verified before being posted in the review tab 214. The verification process may include checking if the reviewer has indeed owned the reviewed product. In one embodiment, the E-commerce website 100 may require the reviewer to upload a photo picture of the reviewed product. The photo picture can be uploaded directly from a camera with web access and can be logged into the same reviewer's account. In another embodiment, the E-commerce website 100 may require the reviewer to enter the product's identification information including the serial number.

When the forum tab 216 is selected, the region 220 will display forum entries pertaining to the for-sale camera 203. In embodiments, the forum entries are displayed right away without going through verification process, so that instantaneous communication among people who are interested in the for-sale camera 203 can happen.

In addition, the first exemplary webpage also includes a chat button 232. Upon clicking the chat button 232, a chat session with an expert representing the for-sale camera 203 can be initiated. In one embodiment, the chat session is conducted between the E-commerce website 100 and a webpage viewer' terminal. In another embodiment, the E-commerce website 100 opens a communication channel between the vendor's terminal and a webpage viewer's terminal, so that the chat session is conducted between the vendor's personnel and the webpage viewer.

Referring to FIG. 2B, a second exemplary webpage is provided to depict the review tab 214 in more details. The region 220 under the review tab 214 now includes a reviewer's area 240 and a vendor's area 250. The reviewer's area 240 displaying a reviewer's rating 242 of the for-sale camera 203 and a reviewer's comment 245. In embodiments, the reviewer's comment 245 includes both pros and cons of the reviewed product. The vendor's area 250 displays a vendor's rating 252 of the product review including the reviewer's rating 242 and the reviewer's comment 245 for their accuracy, etc. In other embodiments, the region 200 under the review tab 214 may also include an expert's area (not show) displaying the expert's rating and comments. The expert may not be associated the vendor and may belong to a media organization. Both the vendor and expert need to pre-register with the E-commerce website and go through appropriate verification processes before posting reviews.

FIG. 3 illustrates a method for generating price information for a particular buyer. In embodiments, the pricing information box 225 of FIG. 2A initially displays a manufacturer's suggested retail price (MSRP) 302, which is previously entered into a database in a server that hosts the E-commerce website 100 by a vendor 124 of a selected product. A potential buyer of that product can earn review credits 314 by reviewing other products he or she already owns. An actual price 326 can be obtained by subtracting the review credits 314 from the MSRP 302. A potential buyer needs to set up an account to store review credit 314 in a database in a server that hosts the E-commerce website100.

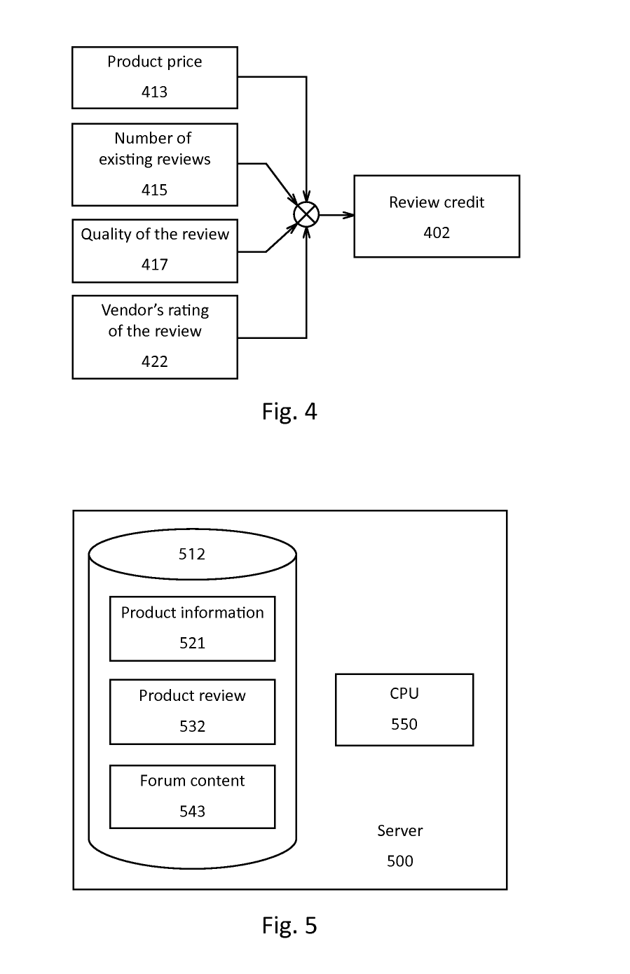

FIG. 4 illustrates a method for calculating review credit for a product reviewer. Review credit 402 is calculated from the product price 413 the reviewer paid for the product, a number of existing reviews 415 for the same product, quality of the review 417 and vendor's rating of the review 422. In some embodiments, reviewing more expensive items, i.e., higher product price 413 may get the reviewer higher review credit 402. If a product has already been reviewed by numerous reviews, i.e., the number of existing reviews 415 is high, the review credit 402 may not gain much. Quality of the review 417 matters, too. For instance, providing cons, in addition to pros, of the reviewed product, is perceived as higher quality and hence boosting the review credit 402. Then vender's rating of the review 422 will proportionally affect the review credit 402. As an example, calculating the review credit 402 can be formulated as (product price 413/A)×(B/(number of existing reviews 415))×(quality of the review 417)×(C/(vendor's rating of the review 422)), wherein A, B and C are coefficients assigned to the product price 413, number of existing review 415, and vendor's rating of the review 422, respectively.

FIG. 5 illustrates a server system 500 that hosts the E-commerce website 100 of the present invention. The server system 500 includes a store 512 for storing product information database 521, product review database 532, and forum content database 543. The product information database 521 includes specifications of all the products either for sale or being reviewed on the E-commerce website 100, as well as associated vendor information. The product review database 532 includes not only all the reviews but also the associated reviewer's information and review credit earned by each reviewer. The product information database 521, the product review database 532 and the forum content database 543 are interlinked. For instance, when entering a product, all its associated reviews and forum content can be extracted from the product review database 532 and forum content database 543, respectively.

Referring again to FIG. 5, the server system 500 also include a central processing unit (CPU) 550 for managing the aforementioned store 512 and for calculating the actual price 326 of FIG. 3 and the review credit 402 of FIG. 4. The CPU 550 may also track number of reviews submitted by a reviewer, and allow only one review per product per reviewer. In some embodiments, separate processing units may be employed to perform the aforementioned operations.

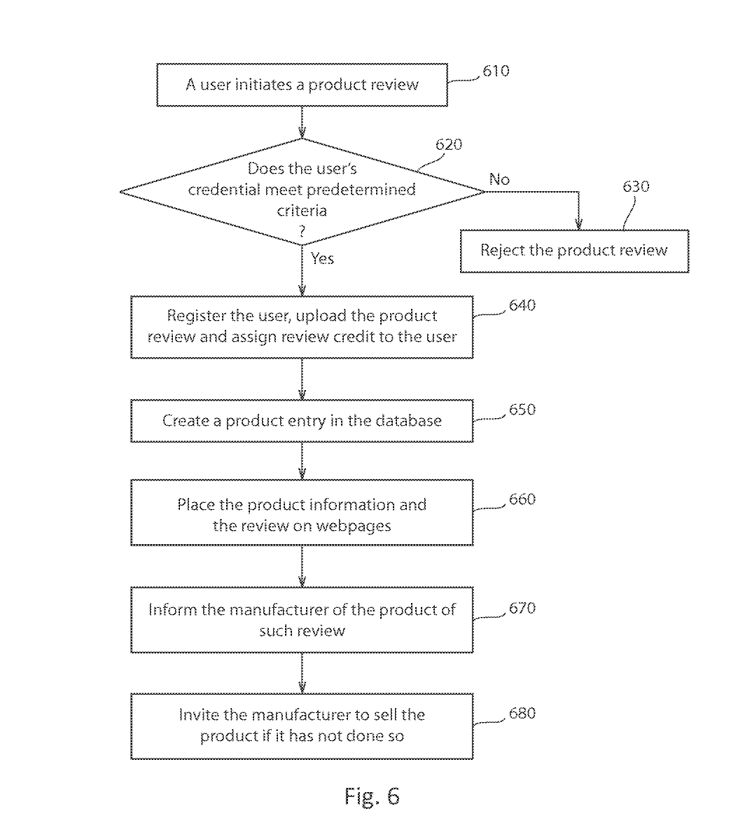

FIG. 6 is a flow chart illustrating a process of a user initiating a product review on the E-commerce website 100. The process begins with a user initiating a product review in step 610 by, for instance, clicking a button on a webpage in his or her terminal which in turn sends a request for entering review to the E-commerce website 100. Step 610 also involves the user providing identification information or credential through a log-in process. In step 620, the E-commerce website 100 checks the user's credential. If the user's credential does not meet predetermined criteria, the product review request will be rejected in step 630. The predetermined criteria may include the user's name, contact information, age, gender, and proof of possessing the reviewed product, etc. If the user's credential meets the predetermined criteria, the E-commerce website 100 will register the user, upload the product review and assign review credit to the user in step 640. The E-commerce website 100 then creates a product entry in the database 512 in step 650, and places the product information and the review on appropriate webpages in step 660. The product information and the review can be displayed upon request of corresponding webpages. Furthermore, the E-commerce website 100 informs the manufacturer of the reviewed product of such review in step 670. The E-commerce website 100 may also invite the manufacturer to list the reviewed product for sale on the E-commerce website 100 if it has not done so already in step 680.

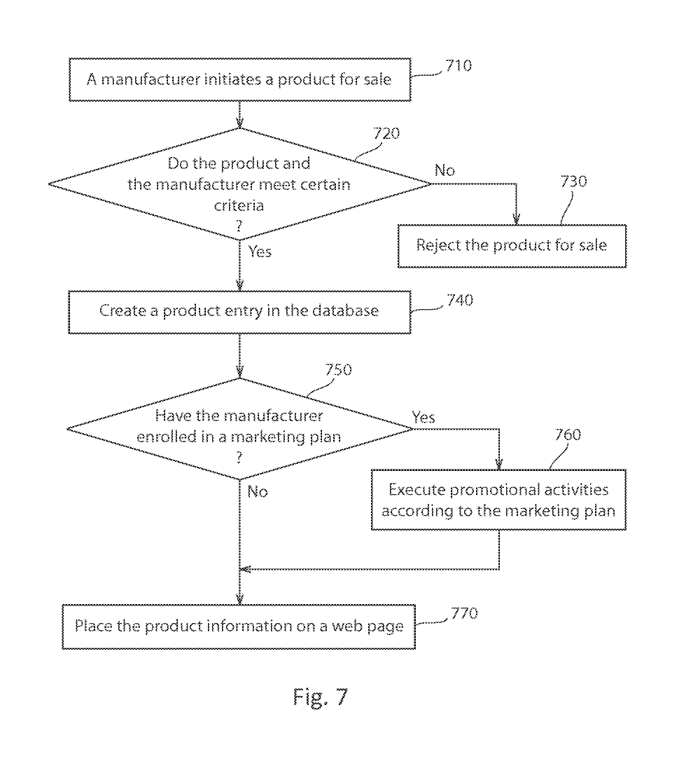

FIG. 7 is a flow chart illustrating a process of a manufacturer initiating a product for sale on the E-commerce website 100. The process begins with a manufacturer initiating a product for sale in step 710 by logging into the E-commerce website 100 and entering the product information therein. The product information may include description, images and MSRP of the product. The E-commerce website 100 then checks the product information and the manufacturer's credential in step 720. If either the product or the manufacturer does not meet certain criteria, the E-commerce website 100 will reject the product for sale in step 730. If both the product and the manufacturer meet the criteria, the E-commerce website 100 will create a product entry in the database 512 in step 740. The E-commerce website 100 also checks if the manufacturer has enrolled in a marketing plan for the product in step 750. The marketing plan may include promotional activities such as blasting promotional emails to users on a mailing list of the E-commerce website 100, and displaying product advertisement on related webpages. If the manufacturer has enrolled in the marketing plan, appropriate promotional activities will be executed in step 760. Notwithstanding the marketing plan enrollment, once the product entry is created, the product information will be placed in a desired webpage for being displayed to the public. In embodiments, there may be multiple similar products from different vendors listed for sale on the E-commerce website 100. The E-commerce website 100 may be programmed to determine a sequence of the product listing according to seniority of a listing, rating by customers or price of the products, or a combination of the above factors.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A system comprising:
a server computer connected to the Internet, the server computer receiving, over the Internet, both a product review and a product inquiry from a user on one or more remote computers, the product being reviewed being different from the product being inquired;
a database containing product information pertaining to the inquired product, the product information including a first price of the inquired product;
a processing unit calculating a second price from the first price and a factor derived from the product review;
a computer program residing in the server computer placing the second price on a webpage pertaining to the inquired product, the computer program also sending the webpage to the user's remote computer.

2. The system of claim 1, wherein the database further contains product reviews pertaining to the inquired product; and the processing unit further obtains a number of product reviews pertaining to the inquired product existing in the database, and uses the number in calculating the second price.

3. The system of claim 1 further comprising a computer program residing in the server computer for evaluating quality of the product review which is then used for deriving the factor.

4. The system of claim 1, wherein the server computer further receives, over the Internet, rating information of the product review from a remote computer belongs to a vender of the reviewed product.

5. The system of claim 4, wherein the processing unit further uses the rating information in calculating the second price.

6. The system of claim 1, wherein the webpage further contains forum content pertaining to the inquired product.

7. The system of claim 1, wherein the computer program sends an electronic message to a vendor of the reviewed product informing of such product review.

8. The system of claim 7, wherein the server computer receives product-for-sale listing information from the vendor's computer in response to the electronic message.

9. The system of claim 1, wherein the computer program places an advertisement for a product other than the inquired product on the webpage.

10. The system of claim 1, wherein the server computer recognize the user by a log-in process.

11. A method comprising:
receiving, using a server computer connected to the Internet, both a product review and a product inquiry from a user on one or more remote computers, the product being reviewed being different from the product being inquired;
retrieving by the server computer a first price of the inquired product from a database;
calculating by the server computer a second price from the first price and a factor derived from the product review;
placing by the server computer the second price on a webpage the inquired product information being placed; and
providing the webpage to the user's computer over the Internet.

12. The method of claim 11 further comprising obtaining, by the server computer, a number of product reviews pertaining to the inquired product existed in the database, and using the number in calculating the second price.

13. The method of claim 11 further comprising evaluating, using the server computer, quality of the product review which is then used for deriving the factor.

14. The method of claim 11 further comprising receiving, by the server computer, rating information of the product review from a remote computer belonging to a vender of the reviewed product over the Internet.

15. The method of claim 11 further comprising providing, by the server computer, reviews pertaining to the inquired product on the webpage.

16. The method of claim 11 further comprising providing, by the server computer, forum information pertaining to the inquired product on the webpage.

17. The method of claim 11 further comprising sending, by the server computer, an electronic message to a vendor of the reviewed product informing of such product review.

18. The method of claim 17, further comprising receiving, by the server computer, product-for-sale listing information from the vendor's computer in response to the electronic message.

19. The method of claim 11 further comprising placing, by the server computer, an advertisement for a product other than the inquired product on the webpage.

20. The method of claim 11 further comprising recognizing the user using a log-in process.
